(19) United States
(12) Patent Application Publication
(10) Pub. No.: US 2024/0338532 A1
(43) Pub. Date: Oct. 10, 2024

(54) DISCOVERING AND APPLYING DESCRIPTIVE LABELS TO UNSTRUCTURED DATA

(71) Applicant: Microsoft Technology Licensing, LLC, Redmond, WA (US)

(72) Inventors: Wolfgang Martin PAULI, Seattle, WA (US); Robert McArn HORTON, Corte Madera, CA (US)

(21) Appl. No.: 18/296,322

(22) Filed: Apr. 5, 2023

(51) Int. Cl. G06F 40/40; G06F 16/35; G06F 40/30

(52) U.S. Cl. CPC G06F 40/40; G06F 16/35; G06F 40/30

(57) ABSTRACT

Example solutions for training machine learning models include: selecting a plurality of training samples from a dataset; generating soft labels for the training samples using a large language machine learning model (LLM); training a student model using the plurality of training samples; evaluating a performance metric of the student model based on a plurality of human-annotated samples; selecting one or more additional training samples from the dataset using a teacher model; generating soft labels for the one or more additional training samples using the LLM; and retraining the student model using at least the plurality of training samples and the one or more additional training samples.

### BACKGROUND

Many organizations have large amounts of unstructured data (e.g., text, images, video, audio), but the data may need to be categorized before it can generate actionable insights. Labeling of unstructured data for machine learning applications is important for building efficient and accurate machine learning models.

### SUMMARY

The disclosed examples are described in detail below with reference to the accompanying drawing figures listed below. The following summary is provided to illustrate some examples disclosed herein. In the following it is not meant, however, to limit all examples to any particular configuration or sequence of operations.

Example solutions for providing an artificial intelligence (AI) assistant include: identifying a plurality of training samples from a dataset via active learning using a teacher model; generating soft labels for the plurality of training samples using a large language machine learning model (LLM); generating a few-shot learning prompt for the LLM, including labeled samples that a student model determines to be similar to a current training sample; training the student model using the plurality of training samples: evaluating a performance metric of the student model based on a plurality of human-annotated ground truth samples; identifying one or more additional training samples from the dataset using the teacher model; receiving first user input identifying annotation data for the one or more additional training samples; and retraining the student model using at least the plurality of training samples and the one or more additional training samples.

### BRIEF DESCRIPTION OF THE DRAWINGS

The disclosed examples are described in detail below with reference to the accompanying drawing figures listed below:

FIG. 1 illustrates an example architecture that advantageously trains machine learning models from unstructured data using active learning techniques in conjunction with input from users;

FIG. 2 illustrates an overview flow, showing three broad steps in model training of an example architecture, such as that shown in FIG. 1:

FIG. 3 illustrates a model architecture for generating sentence embeddings for an example dataset, such as that of FIG. 1, in an example operation such as that of FIG. 2;

FIG. 4 illustrates a training hyperloop flow, showing a training and evaluation cycle performed by an example AI assistant, such as that of FIG. 1, for the student model in an example operation, such as that of FIG. 2:

FIG. 5 illustrates an annotation flow for applying labels to samples of the dataset by an example AI assistant:

FIG. 6 illustrates an example flow of data within an example architecture, such as that of FIG. 1:

FIG. 7 illustrates an example screen of a user interface (UI) in which a graph (or “point cloud graph”) of data points associated with the dataset is displayed to the user:

FIG. 8 illustrates an example screen of the UI after several iterations of training of the student model:

FIG. 9 illustrates example sample performance data for the student model relative to the teacher model:

FIG. 10 is a flowchart illustrating exemplary operations that may be performed by architecture for providing an AI assistant:

FIG. 11 is a flowchart illustrating exemplary operations that may be performed by architecture for providing an AI assistant; and

FIG. 12 is a block diagram of an example computing device (e.g., a computer storage device) for implementing aspects disclosed herein, and is designated generally as a computing device.

Corresponding reference characters indicate corresponding parts throughout the drawings. Any of the drawings may be combined into a single example or embodiment.

### DETAILED DESCRIPTION

It can be difficult for many organizations to generate actionable insights from unstructured data. For example, a large retail company may have many millions of product reviews, written in colloquial English. A research team may like to develop a machine learning (ML) learning solution to identify fraudulent reviews, such as reviews written by bots. The team would therefore typically need a large, annotated dataset to develop a solution. In this dataset, each review is typically labeled as either legitimate, or as falling into one of several categories of fraud.

One known approach to these kinds of scenarios is for the research team to agree on the categories, to define criteria for assigning reviews to different categories, and to develop detailed instructions for external annotation service providers. This can take several iterations, including reviews by all stakeholders, and is technically inefficient. This stage therefore already takes significant computing resources, effort, and time, as categories, criteria, and instructions are refined iteratively. Once this stage is completed, several weeks and thousands of dollars will have been spent before receiving the first results. Upon reviewing these initial results, the research team and stakeholders may realize that further fine-tuning of categories is required, either because some categories are irrelevant or additional categories may have to be added to the taxonomy. Annotation instructions may have to be adjusted as well, as the vendors are producing inconsistent annotations (e.g., inter- and intra-annotator reliability).

In short, previous systems are technically inefficient in producing a high-quality structured dataset, which provides quantitative insights and addresses business-critical research questions. Further, many use-cases exist where the outsourcing or crowdsourcing of data annotation is not an option at all, because data are too sensitive, or because annotation can only be done by domain experts.

The example solutions described herein simultaneously address at least three challenges using aspects of artificial intelligence (AI) and specifically machine learning (ML); (1) avoiding slow and expensive human annotation of entire datasets; (2) allowing taxonomies of categories to evolve dynamically, rather than through a slow iterative process; and (3) unblocking use cases that involve data that is too sensitive to be shared with third parties or can only be annotated by domain experts. The example solutions have applications across various industries including, for example, support ticket routing, insurance claim risk assessment, content moderation, medical record classification, Securities Exchange Commission (SEC) compliance assessment, classification of scientific response documents, categorization of upstream data for exploration, and customer account classification. While the present methods are described in the context of text classification, a common natural language processing (NLP) task, the same principles apply to other unstructured data assets such as audio, video, images, sequences (e.g., DNA), and more.

Example solutions allow the user (e.g., a subject matter expert (SME)) to cooperate with an AI assistant, which simultaneously tries to uncover the hidden dimensions and categories in the data, while also trying to understand the user's intent. As the user cooperates with the AI assistant and provides feedback to suggestions, the user also acquires an intuitive understanding of their data. Once the user is confident that the AI assistant has identified all relevant categories, understood the user's intent, and can reliably assign samples according to the user's instructions, this information is distilled into a light-weight student model (e.g., a conventional ML classifier) that can categorize the entire dataset at a low performance cost (e.g., performable by a conventional central processing unit (CPU) without necessarily needing a graphics processing unit (GPU), and with very high throughput (e.g., greater than 10,000 sentences per second)).

Example solutions combine the use of large language models (LLMs) for creating soft labels used for training a student model and interpreting the intent of users; distilling the knowledge into one or more small student models, which can be stored and used at any future time to index an entire dataset in a cost-effective and high throughput manner; and using active learning to minimize the time the user needs to spend to teach the assistant about their intent.

The example solutions described herein have several technical advantages over existing approaches. Organizations no longer need to depend on costly annotation services by internal teams or external service providers. Stakeholders and researchers can discover relevant dimensions and categories on their own, rather than through an expensive and slow iterative process with teams of human annotators. A student model is trained to eventually index an entire dataset. This contrasts with approaches where large language models are used to categorize an entire dataset, which is computationally much slower and more expensive than using the student model. With the example solutions, the student model can also be stored, registered, and published for later use (e.g., streaming data). Example solutions significantly out-perform one-shot classification and few-shot classification approaches in terms of classification accuracy. Further, example solutions provide a calibrated student model for classification, associating each response with a confidence value, which the researcher can consider when reporting insights to stakeholders, or when including the categorized data in downstream machine learning or analytical workflows.

Example solutions for providing an artificial intelligence (AI) assistant for training machine learning models on a dataset include: identifying a plurality of training samples from a dataset; generating soft labels for the plurality of training samples using a large language machine learning model (LLM); training a student model using the plurality of training samples, the student model being configured to output class membership probabilities; evaluating a performance metric of the student model based on a plurality of annotated samples; identifying one or more additional training samples from the dataset using a teacher model; receiving user input identifying annotation data for the one or more additional training samples; and retraining the student model using at least the plurality of training samples and the one or more additional training samples.

The terms “data sample” or “sample,” as used herein, refer to a single data entry in a corpus of data. Many of the examples described herein use text-based data to highlight implementations of the AI assistant. In such examples, each “sample” of data includes a segment of text, such as a sentence of a customer complaint. In other implementations, a “sample” of data may refer to a single image, video segment, or audio segment that may be similarly used in construction of models as described herein. The terms “data component,” “data example,” “data row,” or “data element” may, additionally or alternatively, be used to describe such data.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

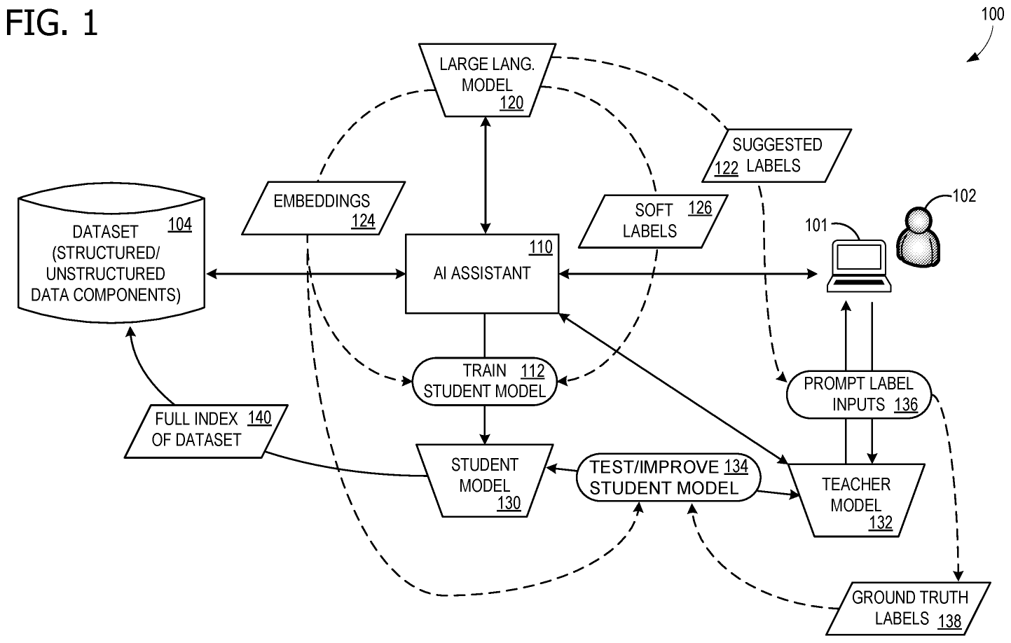

FIG. 1 illustrates an example architecture 100 that advantageously trains machine learning models from unstructured data using active learning techniques in conjunction with input from users. In architecture 100, a user 102 at a user computing device 101 interacts with an AI assistant 110 to train a student model 130 that helps give the user 102 insights they need within a dataset 104 of structured or unstructured data from their organization. The AI assistant 110 performs several rounds of model training on the student model 130 in a training loop, performing some automated, incremental improvements of the student model 130 with automatic selection and categorization of training samples, then prompting the user 102 for additional annotations to help further improve the training process. After several rounds of automated learning and interactive learning, the student model 130 has been configured with a sufficient reliability in categorizing the dataset 104 within the categories of interest to the user 102 that the AI assistant 110 then uses the student model 130 to create a full index 140 of the dataset 104, thus categorizing each of the samples of the dataset 104 and allowing the user 102 evaluate the previously-unstructured data in a new and meaningful way.

In example implementations, the dataset 104 is a set of text data in which each sample is a sentence of text data, and the AI assistant 110 is configured to train a student model 130 to classify the samples of the dataset 104 in a natural language processing use case. For example, an organization may wish to analyze customer churn based on a dataset 104 of text-based customer complaints, where each complaint contains one or more sentences provided by the submitting customer. However, it should be understood that other types of data and use cases are possible.

During operation, the assistant 110 uses a large generative language model (LLM) 120, such as GPT-3, Davinci, Babbage, or the like, for several model training tasks. The LLM 120 is used during user-based annotation, where the user 102 is presented with data samples for manual annotation (e.g., where the user 102 identifies what category(s) the particular sample belongs). In such situations, the AI assistant 110 initially uses the LLM 120 to generate a suggested label 122 for each particular sample (e.g., a category), which the user 102 may accept or may change. As such, the AI assistant helps assist the user 102 in selecting categories of interest within the dataset 104 and helping identify the intent of the user 102 (e.g., a subject matter expert in some focus area or discipline relative to the dataset 104). The LLM 120 is also used to generate semantic embeddings 124 for the samples of the dataset 104, where the embeddings 124 are then used to train 112 the student model 130. The embeddings 124 are generated once for all of the samples of the dataset 104 (e.g., in hundreds of dimensions), and the embeddings 124 are then used during training 112 of the student model 130. The LLM 120 may also be used to generate soft labels 126 for some samples, where soft labels 126 represent automatically-generated initial categorization guesses for those samples that may be used to train 112 the student model 130.

The AI assistant 110 initially generates embeddings 124 for the entire dataset 104 using the LLM 120. At this stage, the AI assistant 110 does not yet have any indication of the areas of interest or intent of the user 102 other than the dataset 104. To begin focusing into the interest of the user 102, the AI assistant 110 provides a user interface (UI) that presents a pictorial representation of the dataset 104, such as a point cloud visualization of how the AI assistant 110 is currently representing the dataset 104. The user 102 is prompted for label inputs 136 for a subset of samples, thus identifying an initial set of ground truth labels 138 for some of the samples. These ground truth labels 138 also identify a set of categories of interest to the user 102 which form the foundation of training for the student model 130.

The AI assistant 110 then begins a training loop to train and refine the student model 130. This training loop includes automated iterations in which the AI assistant improves the training and performance of the student model 130 without assistance from the user 102, selecting samples from the training set, labeling those new samples with soft labels 126 using the LLM 120, training the student model 130 (e.g., as a multilayer perceptron neural network to produce class membership probabilities) and evaluating the current performance of the student model 130 until improvement diminishes. This student model 130 is analyzed by the assistant 110 using pre-labeled data (e.g., a few human-labeled data samples for each category, such as the ground truth labels 138) to test how consistent the soft labels 126 are performing. The assistant 110 trains a teacher model 132 to identify samples within the student model 130 that can help improve the student model 130 with additional human annotation. The assistant 110 prompts the user 102 for label inputs 136 and uses those new label inputs 136 to improve and test 134 the student model 130. This cycle can continue for many iterations until improvement of the student model 130 has peaked.

Once automatic-training performance plateaus, the AI assistant 110 re-engages the user 102 for additional input. The AI assistant 110 examines the current training set to identify samples that can help improve the training process (e.g., samples with soft labels of low confidence). The AI assistant 110 presents these samples to the user 102 for annotation and, as above, the user 102 can confirm the existing soft label 126, suggested label 122, define a new label, or assign an existing label.

Upon concluding a round of user annotation, the AI assistant 110 may similarly perform another round of automatic training, now retraining the student model 130 with a larger set of samples with ground truth labels 138 provided by the user 102. Accordingly, the AI assistant 110 performs iterations of automatic labeling and manual labeling until a performance threshold is reached (e.g., a pre-determined correct categorization percentage) or until the user 102 is content at the current performance of the student model 130. At such time, the AI assistant 110 may perform a full index 140 of the dataset 104 using the student model 130.

In some implementations, the following models are used: an embedding model (large and expensive, such as the LLM 120), a student model 130 (relatively very small), a teacher model 132, and a large language model 120 (e.g., extremely large and computationally expensive). The embedding model is pretrained to generate a sentence embedding for each sample. In some implementations, the assistant 110 is configured to use an embedding model that has been pretrained on a related domain (e.g., a model pretrained on a particular type of filing). The student model 130 takes the embeddings 124 as input to predict user-defined categories (e.g., class labels). The student model 130 can be registered for later use. The teacher model 132 takes the embeddings as input and selects samples for annotation, and is trained to identify unlabeled samples (e.g., sentences) that are difficult for the student model 130 (e.g., where the teacher model 132 has low confidence that the student model 130 will not make a mistake). The teacher model 132 selects unlabeled samples for annotation by a LLM 120 (e.g., soft labels 126) or by the user 102 (e.g., ground truth labels 138). The LLM 120 suggests class labels 122 to the user 102 and generates soft labels 126 for training the student model 130.

The same method is used for manual and automatic iterations, in some examples. That is, the student model 130 is applied to the entirety of human-annotated samples. The student model 130 output is stored and evaluated, noting for each sample whether the output was correct or incorrect. The teacher model 132 is then trained to predict for each of the same samples whether the student model 130 produces a correct or incorrect output. After training the teacher model 132 in that manner, it is applied to unannotated data samples, to identify those where the student model 130 is likely to make a mistake.

In some implementations, during data annotation, the user 102 chooses between entering class labels manually, selecting a suggested label 122 made by the LLM 120 (e.g., existing class or new class), or selecting class labels generated by the LLM 120, or accepts the label predicted by the student model 130). The samples are chosen to provide maximum coverage of class labels, and to avoid bias towards majority class for imbalanced dataset (e.g., balance the classes automatically by pulling more data from certain categories). One goal of the prompt design is to continuously evolve to reflect the current understanding of the data and the intent of the user 102.

As part of an AI-assistance experience, the AI assistant 110 uses the LLM 120 to generate suggestions to the user 102 about how to categorize a datapoint. The assistant 110 is context-aware, as the assistant 110 creates few-shot learning prompts for LLMs 120 in real time. For example, the assistant 110 dynamically re-engineers the few-shot learning prompt. Each time a new sample is sent to the LLM 120 for generating a soft label 126 or label suggestion 122 for the user 102, the assistant 110 includes reference sentences that the student model 130 identifies as similar (e.g., based on cosine similarity between category probabilities). These prompts thus contextualize what the assistant 110 has already learned about the dataset 104 and the intent of the user 102. User cooperation with the assistant 110 provides important feedback to the user 102 about the progress of the project and allows the user 102 to see insights within the dataset 104. The LLM 120 is used to create soft labels 126 for training the student model 130 that can eventually transform the entire dataset 104 with high throughput and without necessarily requiring specialized hardware (GPU). The student model 130 thus represents a compact representation of the dataset 104 and the intent or interest of the user 102, thus greatly reducing storage needs for the model as well as greatly improving computational performance and efficiency relative to traditional modeling techniques. The student model 130 is thus well calibrated, assigning a confidence value for each item in the dataset.

Various examples provided herein use multi-class classification, where a single sample is evaluated and labeled with one class or category identifier from a set of several mutually exclusive classes or categories. For example, under multi-class classification, sample sentences may be labeled as relating to “Athletes”, “Artists”, or “Officeholders”, and thus may be labeled with only one of these three classes (e.g., the highest scoring of the three classes, as identified by a trained student model, or as manually labeled by a user). In some implementations, the AI assistant 110 supports multi-label classification, where a single sample can be labeled with one or more of the classes, and thus where a decision can be made independently whether each particular label applies to a given sample. For example, a sentence discussing a former professional sports figure running for public office may warrant both an Athletes label and an Officeholders label. As such, the AI assistant 110 may be configured to provide multiple suggested labels 122 from the LLM 120 (e.g., the prompt to the LLM 120 may ask for the top n best labels). The AI assistant 110 may similarly generate one or more soft labels 126 during automatic training iterations and may assign multiple soft labels 126 to a particular sample (e.g., all soft labels exceeding a particular confidence threshold). The user 102 can configure whether their analysis and this student model 130 is being constructed to support multi-class classification or multi-label classification.

Various examples provided herein are described for a single modality of data (unimodal), and using primarily text-based data, large language models to interpret text and generate text-based output, and the training of models configured to help classify text-based data. In some implementations, the AI assistant 110 is configured to support other modalities of data, such as, for example, image-based data, audio-based data, or video-based data. In some implementations, the AI assistant 110 is configured to support multiple types of media or modalities of data (multimodal), such as a combination of audio and text (e.g., customer voice complaint calls and online text-based complaints to classify types of complaints, or joint vision-language models), or images, video, and text (e.g., professional images of people, video interviews, and their text-based biographies, to classify occupation types), or other multi-modal deep learning models. As such, and in addition to or alternatively, other model types may be used to support other modalities. For example, an image classification model such as EfficientNet, ViT (Vision Transfomer), or DenseNet may be used to generate suggested labels 122 or soft labels 126 for image-based data, a model for action recognition in videos, such as I3D, may similarly be used for video-based data.

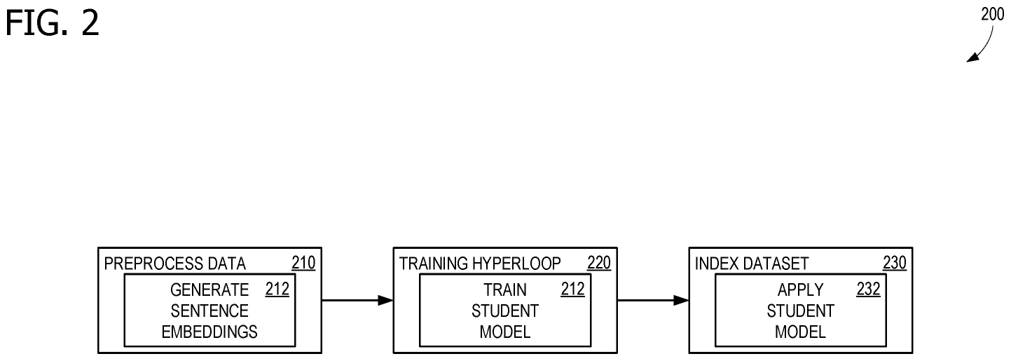

FIG. 2 illustrates an overview flow 200, showing three broad steps in model training of the architecture 100 shown in FIG. 1. The AI assistant 110 performs preprocessing of the dataset 104 at operation 210, including generating sentence embeddings at operation 212 using an embedding model (e.g., the LLM 120 of FIG. 1). The assistant 110 performs a training hyperloop at operation 220, which includes several iterations of training the student model 130 at operation 212, evaluating the current effectiveness of the student model 130 using the teacher model 132 in conjunction with additional annotation prompts and input from the user 102. Once the student model 130 has been sufficiently trained (e.g., little to no improvement is available with further training) with a subset of the dataset 104, the assistant 110 indexes the entire dataset 104 at operation 230, including applying the student model 130 to each sample of the dataset 104 at operation 232.

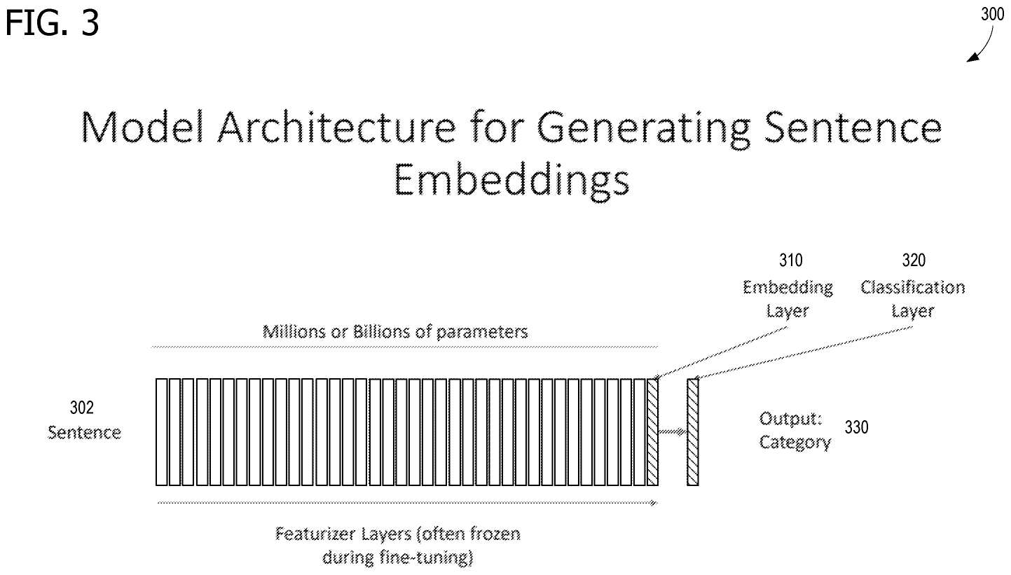

FIG. 3 illustrates a model architecture 300 for generating sentence embeddings 124 for the dataset 104 as in operation 212 of FIG. 2. The assistant 110 uses the LLM 120 to generate an embedding layer 310 from the dataset 104, and student model 130 is trained as a classification layer 320 to output category data 330 for samples 302 (e.g., sentences) from the dataset 104. Sentence embeddings 124 represent the semantic meaning of a sample 302 of text. Embeddings 124 are generated once during data pre-processing. The student model 130 predicts sentence category 330 based on sentence embeddings 124. The user 102 can choose among different model architectures for generating sentence embeddings (e.g., BERT-base-uncased). Sentence embeddings 124 can be reused across use cases (e.g., training distinct student models 130 for each use case). In some implementations, the assistant 110 is configured to use a single class or category 330 for each sample of the dataset 104. In some implementations, the assistant 110 is configured to perform multi-classification, where each sample of the dataset 104 can be assigned one or more labels or categories 330.

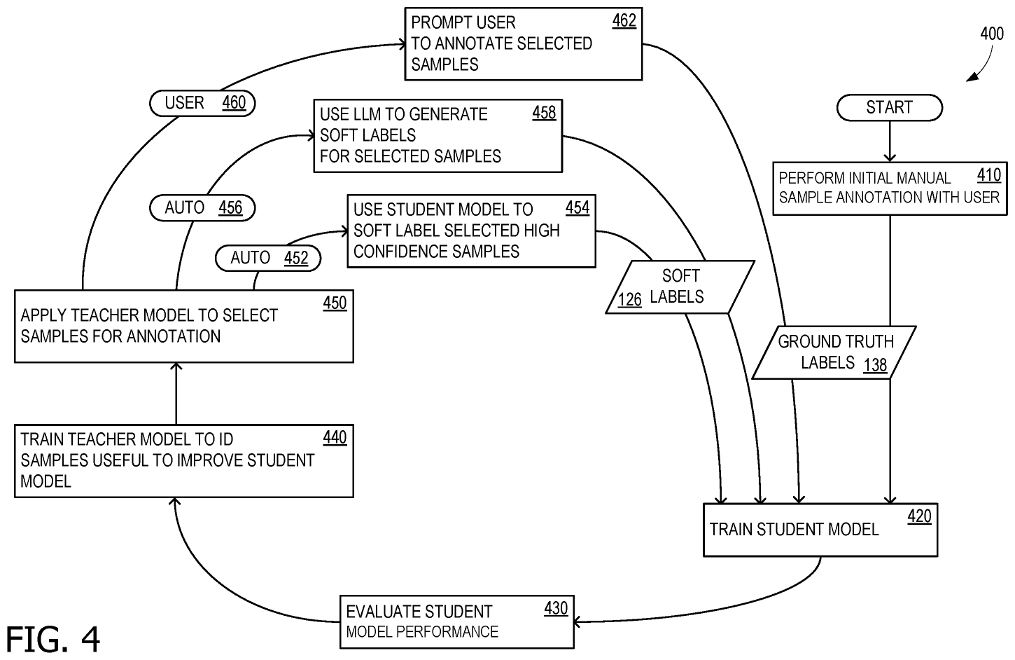

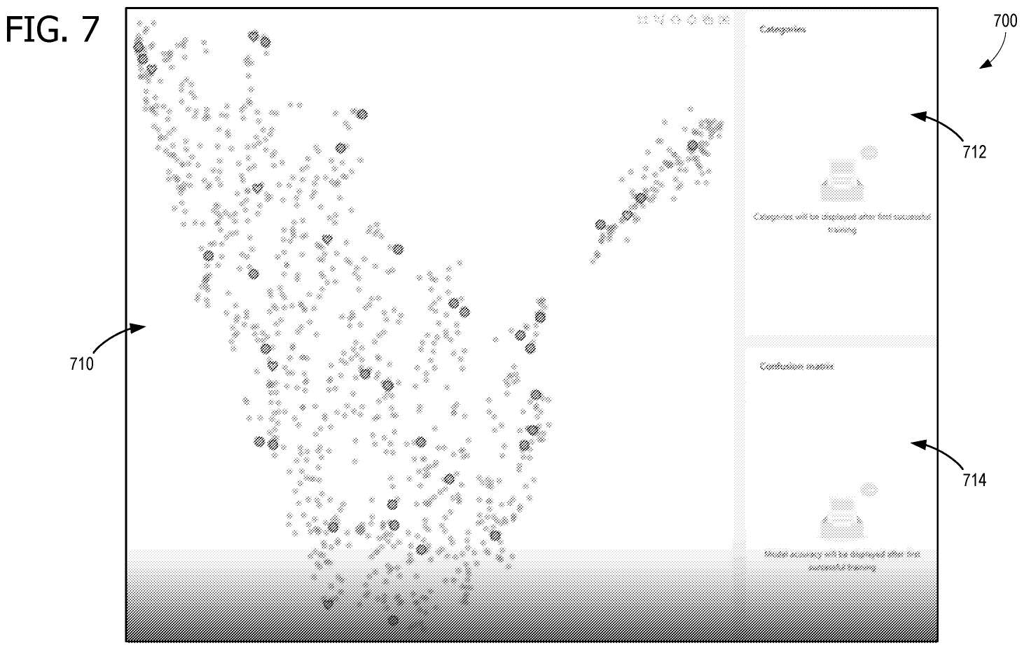

FIG. 4 illustrates a training hyperloop flow 400, showing a training and evaluation cycle performed by the AI assistant 110 of FIG. 1 for the student model 130 such as in operation 220 of FIG. 2. The flow 400 begins at operation 410, in which the AI assistant 110 performs an initial sample annotation with the user 102. The AI assistant 110 provides a user interface (UI) that displays a current representation of the dataset 104 in a point cloud graph provided in a two-dimensional space, where each point or dot represents one sample of the dataset 104. An example UI 700 with a point cloud graph is shown in FIG. 7. At this stage, the user 102 has not yet provided any categorization of any of the dataset 104, and thus nothing is known about the intentions or interests of the user 102.

The user 102 begins providing some manual annotations to samples via this UI. The user 102 may, for example, select one or more samples to annotate by clicking on one of the points on the graph. In some implementations, the AI assistant 110 may automatically select several samples for annotation and prompt the user 102 through annotation of each of these samples. In some implementations, the AI assistant may select and visually highlight several samples for annotation by displaying larger dots for those samples that would be best to annotate (e.g., based on a cluster analysis). The user 102 may be prompted to identify and label two or three samples per category to provide a sufficient starting point, or more for better results.

During manual sample annotation of a particular sample, the user 102 is presented with data about that sample, including the text of the sample, a current label (e.g., category) assigned to the sample (if any), and a suggested category or label 122 for that sample (as generated by the LLM 120 using the sample text as input). The user 102 can use the suggested label 122 for the sample, or may define a new category or assign the sample to an existing category. This labeling becomes a ground truth 138 for that sample.

In some implementations, the assistant 110 performs cluster analysis of the embeddings 124 and, for each cluster, may sample a few points to show the user 102. This approach of clustering at the early stage, rather than letting the teacher model 132 choose, is because there is not enough data yet to train the teacher model 132. For example, the assistant 110 identifies 25 clusters and, from within each cluster, selects a centered sample, one or more fringe or outlier samples (e.g., samples within the cluster but somewhat distant from the center), and a few random samples within the cluster region. These cluster selections can be shown to the user 102 to create initial annotations (e.g., two samples per category). The user 102 can click on the selected points to see data about the samples and provide feedback. The assistant 110 then uses the user-annotated samples to generate soft labels for the samples to train the student model 130 (e.g., start with zero shot learning and then move into few-shot learning). Samples may be shown to the student model 130 to identify a set of top categories. Sentences can be selected from these top categories and provided as context to the LLM engine 120 to train the student model 130, test the student model 130 against human annotated samples, and loop repeatedly through model retraining until improvement diminishes.

Once the initial manual sample annotation is complete, the AI assistant enters a training loop. This training loop begins with training of the student model 130 at operation 420. The AI assistant 110 identifies a set of training samples to use in this current iteration of training of the student model 130. The student model 130 is exclusively trained on soft-labeled samples (soft-labeled by the LLM engine 130). Ground truth labels are only used for evaluating the student model 130. Evaluation involves exclusively ground truth labels. One bootstrapping mechanism uses clustering in the beginning, because there is not enough (or any) ground truth data to evaluate the student model 130, to then train the teacher model 132. The student model 130 is trained, in the example implementation, as a multilayer perceptron neural network configured to produce class membership probabilities for input samples to the set of categories identified by the user 102 (e.g., the set of unique categories defined in the ground truth labels 138).

Once initially trained, the AI assistant 110 is configured to evaluate the performance of the current build of the student model 130 at operation 430. This evaluation includes testing the current training samples with ground truth labels 138 with the student model 130 to determine an overall accuracy percentage. The AI assistant 110 may track model performance data through several automatic iterations of this training loop and may compare prior performance data to the current performance data of the student model 130 to, for example, determine whether the prior iteration of additional samples have improved the model performance. This performance data may be used to determine whether the upcoming training will continue with automatic model training at operations 452-458 (e.g., when performance is still improving under automatic model training) or branch out to collect additional manual annotation data from the user 102 at operations 460-462 (e.g., when automatic model training has ceased to yield performance improvements using only soft labels 126 from the LLM 120).

At operation 440, the AI assistant 110 trains a teacher model 132 that is configured to identify samples from the dataset 104 that, if annotated (either through soft-labeling by the LLM 120 or manual labeling by the user 102), are likely to improve the student model 130. At operation 450, the AI assistant 110 applies the teacher model 132 to identify samples for further annotation. These additional samples are identified, by the teacher model 132, because they are more likely to improve the student model 130 once annotated and included in the training set.

The AI assistant 110 relies on three categories of sampling strategies; uncertainty-based sampling, diversity-based sampling, and meta-active learning. Uncertainty-based sampling strategies work very reliably, using a model's uncertainty about samples as guidance. Alternative formalizations of uncertainty can include:
least confidence sampling (e.g., for each instance, only the confidence for the most likely answer is recorded, and samples with a lower maximal confidence are more likely to be selected for annotation);
margin of confidence sampling (e.g., an instance is more likely to be selected for annotation if the difference between the two most confident answers is smaller);
ratio of confidence (e.g., like margin of confidence sampling but using the ratio between the two most confident answers, rather than the difference—that is, if there are two instances, where the model produced the same margin for the top two confidences, this strategy would pick the one where the confidences are overall lower); and
entropy-based sampling (e.g., an instance is more likely to be selected for annotation if the model produces similar confidence values for all answers).

In addition to these basic sampling strategies, example solutions also leverage more advanced sampling strategies. One of these is known as active transfer learning, where an antagonistic agent (herein, the teacher model 132) selects those samples that the model is likely to get wrong. Another approach has formulated active learning as a regression problem, selecting those samples for annotation that are expected to lead to better performance on a held-out test set. In practice, no single active learning strategy reliably outperforms others. As such, example solutions use a meta-active learning approach that learns to choose and blend alternative sampling strategies based on how well they have worked for a given dataset. Finally, to ensure AI Fairness, example solutions also implement diversity-based sampling to identify and reduce bias, to ensure that training data represents real-world diversity accurately. The user 102 has the option to specify demographic dimensions that must be considered (e.g., gender, socioeconomics, race, ethnicity). To reduce bias when applying active learning, the assistant 110 does stratified active learning within each demographic.

Once several additional samples are identified, the AI assistant 110 determines whether to continue with automatic labeling operations or to prompt the user 102 for manual annotation. In the example implementation, if the current student model performance has improved by a predetermined threshold as compared to the performance of the previous student model (e.g., a performance differential of more than 1% improvement), then the AI assistant 110 continues with automatic labeling operations. If, on the other hand, the current student model performance has not exceeded that improvement threshold, then the AI assistant 110 prompts the user 102 for another round of manual annotation.

For example, when the AI assistant 110 determines to continue with automatic labeling, the AI assistant 110 uses the LLM 120 to generate soft labels 126 for each of the newly selected samples at operations 456-458 and these samples and their soft labels are subsequently used to retrain the student model 130 at operation 420.

In some implementations, the AI assistant 110 may use the current student model 130 to determine a soft label 138 for one or more of the selected samples and a confidence score for that soft label 138. If the confidence score of a particular soft label is above a predetermined threshold for that sample (e.g., if the student model 130 seems to indicate, with a degree of certainty, that the sample falls into one of the defined categories), then that soft label is automatically added to the sample at operations 452-454.

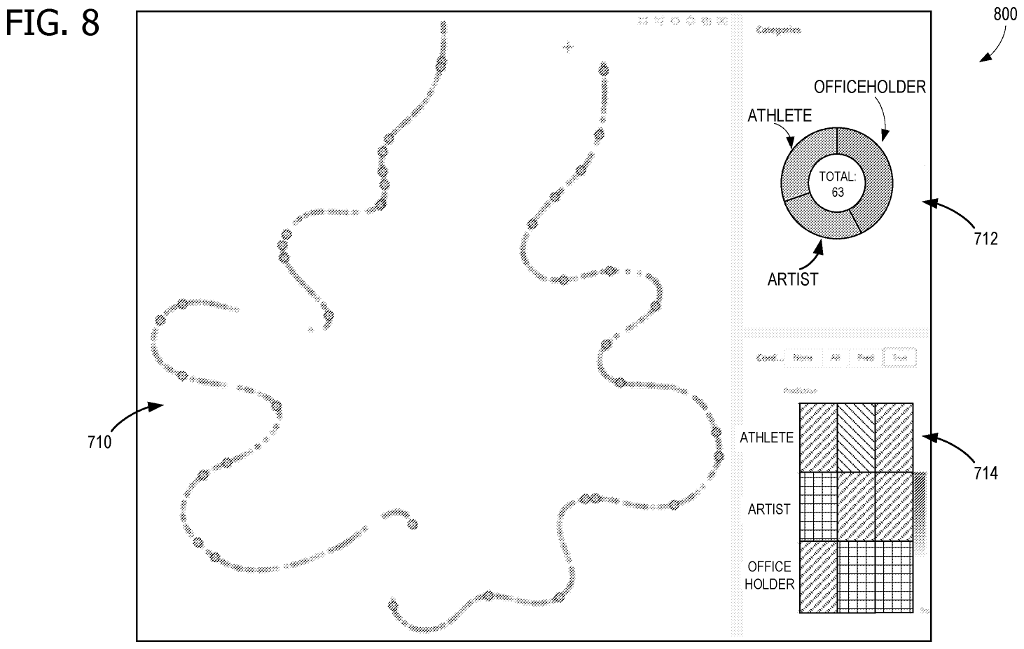

When the AI assistant 110 determines to continue with manual labeling, the AI assistant 110 presents the UI to the user 102 for manual sample annotation. At this stage, the student model 420 has undergone one or more rounds of training, and thus there may be more structure to the data displayed on the point cloud graph. FIG. 8 illustrates a graph in which there is a serpentine structure to the graph. The UI prompts the user 102 to annotate each one of the identified samples, allowing the user 102 to view the text of the sample alongside a category recommendation from the LLM 120 and/or from the student model 130, as well as set or change the label for that sample. The UI may allow the user to select individual points within the graph, or select several points within a region of the graph (e.g., by dragging an area box that bounds a set of points), and additionally or alternatively annotate those particular samples. Each of these newly labeled samples similarly are added to the annotated samples of ground truth labels 138. As such, this next iteration performs a retraining of the student model 130 at operation 420, with additional ground truth samples 138 in the training set.

This training loop may proceed through many iterations, sometimes performing several automatic iterations in which adding new samples to the training set with automatically-generated (LLM-created) soft labels until performance improvements diminish, then proceeding to engage the user 102 for additional manual labels. This cyclic training loop leverages the LLM 120 or the prior student model 130 to generate guesses as to labeling for new samples so long as model performance continues to improve, then has the user 102 engage and label particularly difficult samples (e.g., boundary or fringe samples) to help refine the student model 130.

Example solutions take advantage of active learning. Active learning approaches aim to identify those data points that are most critical for training a model to understand and categorize a dataset. Here, active learning is used for at least two purposes, namely for selecting those samples that require feedback from the domain expert, and to select samples to be annotated by the LLM 120, to further reduce computing resource usage, training time, and cost. Several sampling strategies are implemented, and the strategy is dynamically selected which is most likely to be successful, given characteristics of the dataset and what has already been learned about it.

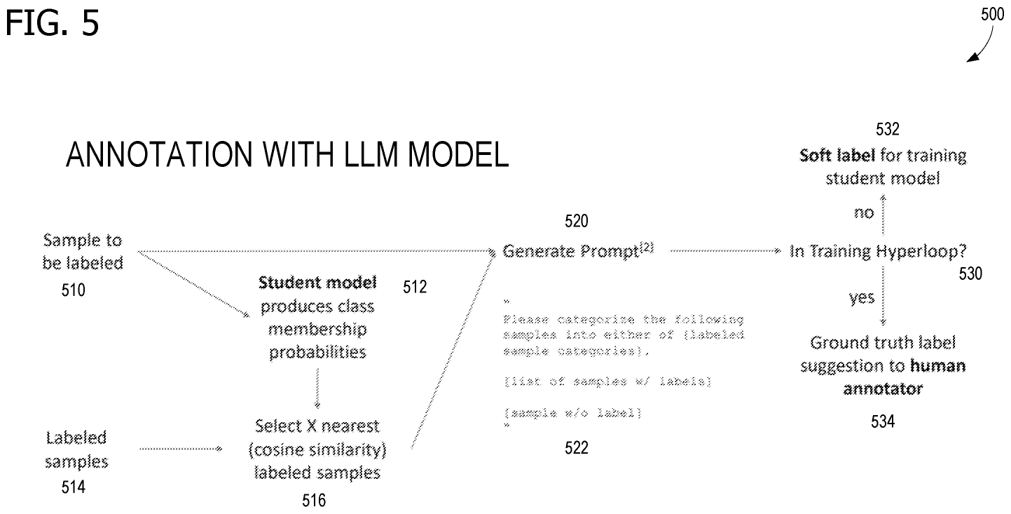

FIG. 5 illustrates an annotation flow 500 for applying labels to samples of the dataset 104 by the AI assistant 110. At operation 512, a sample 510 to be labeled is input to the student model 130 to produce class membership probabilities for each of the defined classes. At operation 516, the AI assistant selects one or more nearest labeled samples to the sample to be labeled (or just “sample”) 510 (e.g., based on cosine similarity to labeled samples 514). At operation 520, the AI assistant generates a prompt that includes a request to categorize the sample 510 to be labeled, as well as a list of the current categories, the text of the sample 510 to be labeled, and the text for each of the nearby sampled labels 514. At decision 530, if the current iteration is an automatic iteration (e.g., at operations 456-458), then this prompt 522 may be submitted to the LLM 120 to generate a soft label 126 for this sample 510 at operation 532. If the current iteration is a manual iteration (e.g., at operations 460-462), then this prompt 522 may be displayed to the user 102 via the UI, asking the user 102 to categorize the sample to be labeled 510 at operation 534. This prompt 522 may display the sample data and allow the user 102 to select one or more categories or labels for that sample 510, or to create a new category for the sample 510.

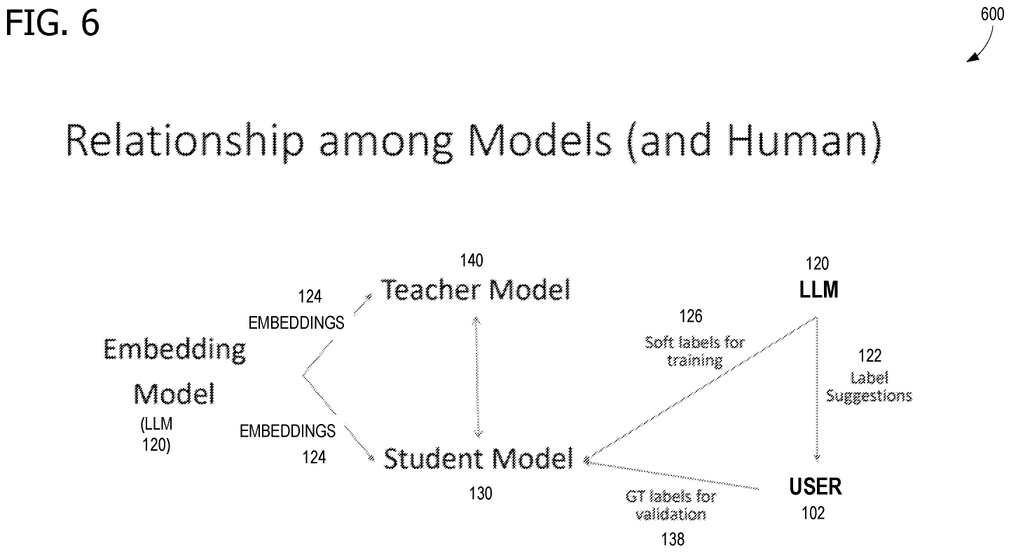

FIG. 6 illustrates an example flow 600 of data within the architecture 100 of FIG. 1. An embedding model (e.g., the LLM 120) generates embeddings 124 for the dataset 104. These embeddings 124 are used as inputs to both the student model 130 and the teacher model 132. The LLM 120 generates label suggestions 122 for samples that are annotated by the user 102, and also generates soft labels 126 that are used for training the student model 130. The user 102 provides ground truth labels 138 during manual annotation of the training data for the student model 130.

FIG. 7 illustrates an example screen 700 of a user interface (UI) in which a graph (or “point cloud graph”) 710 of data points associated with the dataset 104 is displayed to the user 102. The graph 710 includes numerous data points of training data in a two-dimensional (2D) representation, where each data point represents a single training sample (e.g., a single text sentence) of the dataset 104 that is currently being used to train the student model 130. The larger points can represent sample points for which annotations are being requested by the assistant 110. The graph 710 may be interactive, allowing the user 102 to select a particular sample and data associated with that sample (e.g., text of the sample, soft-label or annotated label, current confidence score for the label). A categories frame 712 is provided to show details about the various categories that are currently being used as labels for this analysis. At this stage of analysis, no labels have yet been assigned to any samples and, as such, the categories frame 712 displays no category data. A confusion matrix frame 714 is also provided. The confusion matrix frame 714 displays model accuracy information after a first successful training.

In some examples, FIG. 7 represents a two-dimensional t-SNE (t-Distributed Stochastic Neighbor Embedding) plot, which is a visualization tool that visualizes high-dimensional data in a two-dimensional space while preserving pairwise similarities between data points. The two axes in a 2D t-SNE plot represent two different dimensions in the low-dimensional space. In general, t-SNE does not preserve the original meaning of the dimensions in the high-dimensional space, and the axes in the t-SNE plot do not have a direct physical interpretation. Instead, the relative positions of the data points in the t-SNE plot are what matters. The distances between the data points in the t-SNE plot reflect the similarities between them in the high-dimensional space, with closer points indicating higher similarities. The t-SNE plot reveals the underlying structure of the data in a way that is easy to visualize and interpret, and this is achieved by examining the relative positions and distances between the data points in the plot.

FIG. 8 illustrates an example screen 800 of the UI after several iterations of training of the student model 130. In this example, the user 102 has provided three primary categories (labels) of interest associated with the training data: “Athlete”, “Artist”, and “Officeholder.” After several training iterations, the graph 710 now shows a snaking structure in the data. Each category is represented by a distinct color, both within the dots of the graph 710 and within the categories frame 712, where a particular point on the graph 710 is colored based on its soft- or human-annotated label. The categories frame 712 displays a pie chart of the three categories and associated statistics (e.g., 63 total samples, 27 of which are Orange officeholders, 19 of which are Athletes, and 17 of which are Artists).

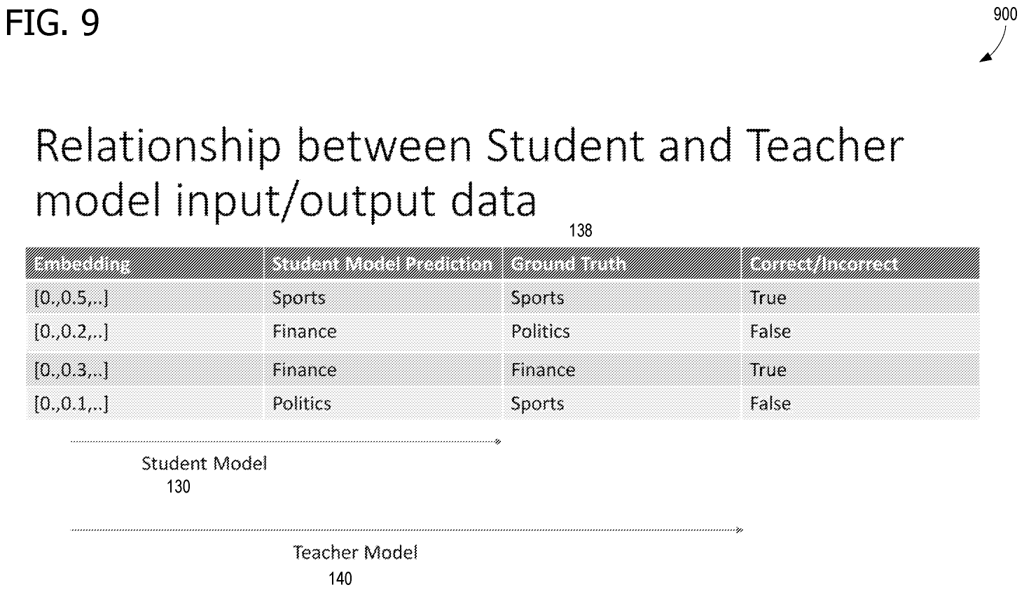

FIG. 9 illustrates example sample performance data 900 for the student model 130 relative to the teacher model 132. Student model predictions and associated embeddings are shown for several samples relative to a ground truth.

Some example solutions as described herein assist the user 102 in making sense of the data, allowing the user many degrees of control. Transparency, trust, confirmation, reversible actions, manual overriding, error prevention and error recovery are all important to keep the user 102 in control of the analysis. Example solutions also assist the user 102 in real time, enabling them to make sense of data for time-sensitive projects. The assistant 110 may allow supervised model training without needing to complete human-performed data annotation on the training set. Example solutions also provide nontrivial context-relevant actions, simultaneously considering what the assistant 110 has already learned about the data as well as the nature of the user's interest. Use of example solutions can have a significant impact on top-level business key performance indicators (KPIs) the users care about (e.g., quickly identifying and responding to trends in customer feedback). Further, example solutions offer a persistent presence in assisting the user to make sense of their data, allowing the state of a project can be saved and restored from memory and learning from its cooperation with the user to improve its accuracy over time. Elements of a user interface provide intuitive visualizations of the model and its understanding of the data and the users' interest in it, allowing the user to achieve state of the art accuracy with minimal effort in terms of time and upskilling.

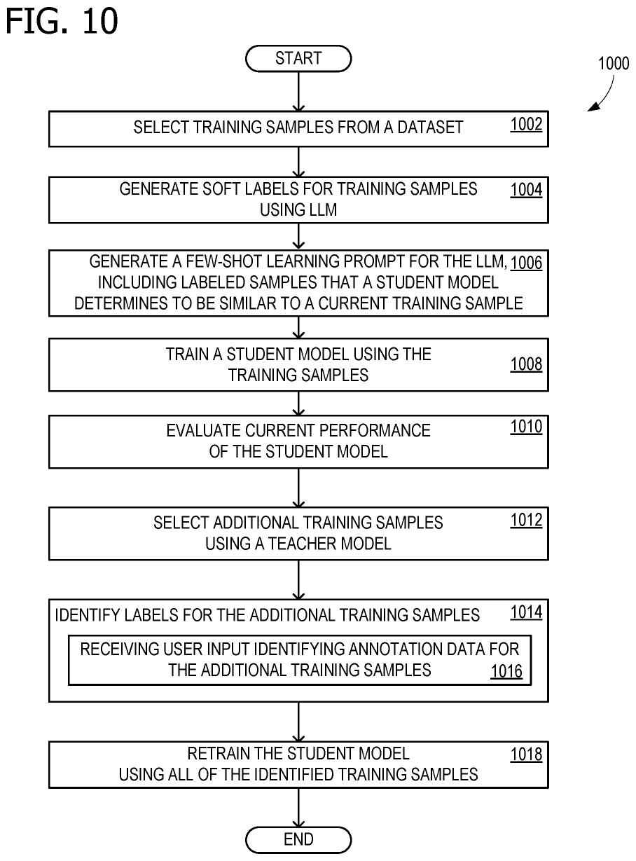

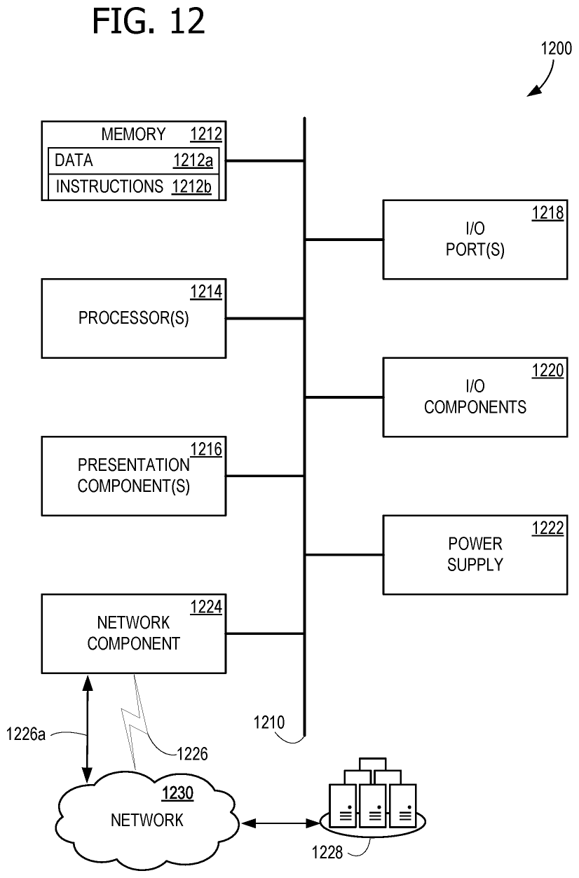

FIG. 10 is a flowchart 1000 illustrating exemplary operations that may be performed by architecture 100 for providing an AI assistant 110. In some examples, operations described for flowchart 1000 are performed by the model training assistant 110 of FIG. 1 executed by computing device 1200 of FIG. 12. Flowchart 1000 commences with the assistant 110 selecting a plurality of training samples from a dataset 104 at operation 1002.

In operation 1004, assistant 110 generates soft labels for the plurality of training samples using a large language machine learning model (LLM). In operation 1006, assistant 110 generates few-shot learning prompts for the LLM 120, where the learning prompts include labeled samples that a student model determines to be similar to a current training example. In operation 1008, assistant 110 trains a student model using the plurality of training samples. In operation 1010, assistant 110 evaluates current performance of the student model (e.g., based on a performance metric) based on a plurality of annotated samples. In operation 1012, assistant 110 selects one or more additional training samples from the dataset using a teacher model.

In operation 1014, assistant 110 identifies labels for the one or more additional training samples. In some examples, operation 1014 includes generating soft labels for the one or more additional training samples using the LLM at operation 1016. In some examples, operation 1014 includes receiving user input identifying annotation data for the additional training samples at operation 1016. In operation 1018, assistant 110 retrains the student model using at least the plurality of training samples and the one or more additional training samples.

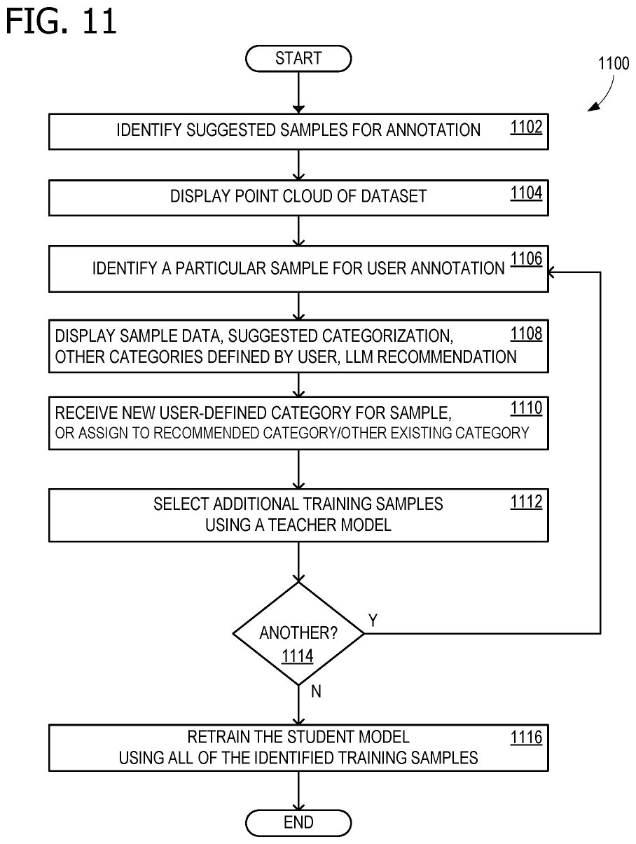

FIG. 11 is a flowchart 1000 illustrating exemplary operations that may be performed by architecture 100 for providing an AI assistant 110. In some examples, the operations of flowchart 1100 may be performed in lieu of, or in addition to, some of the operations shown in FIG. 10. At operation 1102, assistant 110 identifies suggested samples for annotation. At operation 1104, assistant 110 displays a graph (e.g., a point cloud graph) of the dataset 104 or of a current training set of data. This display may be similar to the graphs 710 shown in FIG. 7 and FIG. 8. This graph may be interactable, allowing the user 102 to, for example, click on an individual point within the graph 710, or select a region within the graph 710, to identify one or more points for annotation.

At operation 1106, a particular sample is identified for annotation. In some examples, the assistant 110 may identify points for annotation and may prompt the user 102 with those points. In some examples, the user 102 may identify points for annotation by selecting points within the graph 710. When one or more points are identified, the assistant 110 displays sample data for those points at operation 1108. This displayed data for each sample can include the text associated with the sample, a current label assigned to the sample, and a suggested label for the sample (as generated by the LLM or by the current student model). At operation 1110, the assistant 110 receives user input identifying a new user-defined category for the sample (creating a new label for the training sample set) or receives user input identifying an existing category (or the suggested label) to assign to the sample.

At operation 1112, the assistant 110 selects additional training samples using the teacher model. If there are additional training samples identified for human labeling at decision point 1114, the assistant 110 returns to operation 1106 for another human labeling of the sample. If there are no additional samples queued for human labeling at this time, the assistant retrains the student model using all human-annotated training samples at operation 1116.

### Additional Examples

In some examples, the student model is only 23 kilobytes, and hence easily stored, transmitted, and processed. The student model is also technically efficient, capable of processing 10,000 sentence embeddings per second, compared to an LLM which typically handles 5 calls per second. While the LLM takes text as input, the student model uses sentence embeddings during training. In some implementations, the embedding model generates the embeddings for sentences in the background (e.g., while the user interacting with the assistant).

An example system comprises: a processor; and a computer-readable medium storing instructions that are operative upon execution by the processor to: identify a plurality of training samples from a dataset via active learning using a teacher model: generate soft labels for the plurality of training samples using a large language machine learning model (LLM); dynamically alter a few-shot learning prompt for the LLM, including labeled samples that a student model determines to be similar to a current training sample; train the student model using the plurality of training samples, the student model being configured to output class membership probabilities: evaluate a performance metric of the student model based on a plurality of human-annotated ground truth samples; identify one or more additional training samples from the dataset using the teacher model: receive first user input identifying annotation data for the one or more additional training samples; and retrain the student model using at least the plurality of training samples and the one or more additional training samples.

An example computer-implemented method comprises: identifying a plurality of training samples from a dataset via active learning using a teacher model; generating soft labels for the plurality of training samples using a large language machine learning model (LLM); generating a few-shot learning prompt for the LLM, including labeled samples that a student model determines to be similar to a current training sample: training the student model using the plurality of training samples: evaluating a performance metric of the student model based on a plurality of human-annotated ground truth samples; identifying one or more additional training samples from the dataset using the teacher model: receiving first user input identifying annotation data for the one or more additional training samples; and retraining the student model using at least the plurality of training samples and the one or more additional training samples.

One or more example computer storage devices having computer-executable instructions stored thereon, which, on execution by a computer, cause the computer to perform operations comprising: identifying a plurality of training samples from a dataset via active learning using a teacher model; generating soft labels for the plurality of training samples using a large language machine learning model (LLM); generating a few-shot learning prompt for the LLM, including labeled samples that a student model determines to be similar to a current training sample: training the student model using the plurality of training samples, the student model being configured to output class membership probabilities: evaluating a performance metric of the student model based on a plurality of human-annotated ground truth samples; identifying one or more additional training samples from the dataset using the teacher model; receiving first user input identifying annotation data for the one or more additional training samples; and retraining the student model using at least the plurality of training samples and the one or more additional training samples.

Alternatively, or in addition to the other examples described herein, examples include any combination of the following:
displaying a user interface (UI);
a UI comprising a graph comprising a plurality of data points, each data point representing a data sample from a dataset 104 or a training sample from a plurality of training samples;
receiving user input indicating selection of a data point from a graph;
displaying sample data associated with a data point;
receiving user input identifying a label for assignment to a data point, thereby causing the first data point to become a human-annotated training sample of the one or more additional training samples used to retrain the student model;
in response to receiving user input indicating selection of a data point, causing an LLM to generate a label recommendation for the data point;
displaying sample data associated with the first data point includes causing a label recommendation to be displayed;
receiving user input indicating selection of a region of a graph;
identifying one or more data points occurring within an identified region of a graph;
displaying sample data for each data point occurring within a selected region of a graph;
receiving user input identifying a label for each data point within a selected region of a graph;
performing a plurality of iterations of student model retraining;
comparing a current performance metric of the current student model to a previous performance metric of a prior student model at each iteration of student model retraining;
the performance metric is a performance differential;
adding one or more additional soft labeled training samples to the plurality of training samples if the performance differential is above or below a predefined threshold;
adding one or more additional human-labeled training samples to the plurality of training samples when the performance differential is above or below a predefined threshold;
determining, using the student model, a class membership probability for a first sample belonging to a first class;
assigning the first class as a soft label to the first sample if the class membership probability is above a predefined threshold;
a student model is trained as a multilayer perceptron neural network configured to produce class membership probabilities for input samples;
a plurality of training samples include text-based data; and
generating embeddings for a plurality of training samples using the LLM;
performing a full index of a dataset 104 using a trained student model;
training a teacher model that is configured to identify samples that can help improve the performance of a student model;
display aggregate annotation data for a training set in a UI;
display a confusion matrix in a UI;
a graph that includes some points with a larger dot than other points, where the larger dots indicate one or more of samples that have already been annotated by a human, samples that are identified for annotation by a human; and
a graph that colors points based on one or more of the sample's current annotation and the sample's highest probability categorization as determined by a student model.
apply the retrained student model to input data to classify the input data, wherein the input data is selected from a group consisting of the following: a support ticket, an insurance claim, social media content, a medical record, an image, a video, stock exchange data, an online review, a customer complaint, a video interview, a DNA sequence, and a biography.
apply the retrained student model to input data to classify the input data, wherein the input data is selected from one or more of the following: a support ticket, an insurance claim, social media content, a medical record, an image, a video, stock exchange data, an online review, a customer complaint, a video interview, a DNA sequence, or a biography.
apply the retrained student model to input data to classify the input data, wherein the input data is selected from: a support ticket, an insurance claim, social media content, a medical record, an image, a video, stock exchange data, an online review, a customer complaint, a video interview, a DNA sequence, and/or a biography.
apply the retrained student model to input data to classify the input data, wherein the input data is selected from a group consisting of the following: text, audio, video, and an image.
apply the retrained student model to input data to classify the input data, wherein the input data is selected from one or more of the following: text, audio, video, or an image.
apply the retrained student model to input data to classify the input data, wherein the input data is selected from: text, audio, video, and/or an image.
apply the model to classify a review, then remove the review if the review is classified as fraudulent or bot-created.
apply the model to classify a customer complaint, then forward the complaint to a customer service representative based on the classification.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 12 is a block diagram of an example computing device 1200 (e.g., a computer storage device) for implementing aspects disclosed herein, and is designated generally as computing device 1200. In some examples, one or more computing devices 1200 are provided for an on-premises computing solution. In some examples, one or more computing devices 1200 are provided as a cloud computing solution. In some examples, a combination of on-premises and cloud computing solutions are used. Computing device 1200 is but one example of a suitable computing environment and is not intended to suggest any limitation as to the scope of use or functionality of the examples disclosed herein, whether used singly or as part of a larger set. Neither should computing device 1200 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1200 includes a bus 1210 that directly or indirectly couples the following devices: computer storage memory 1212, one or more processors 1214, one or more presentation components 1216, input/output (I/O) ports 1218, I/O components 1220, a power supply 1222, and a network component 1224. While computing device 1200 is depicted as a seemingly single device, multiple computing devices 1200 may work together and share the depicted device resources. For example, memory 1212 may be distributed across multiple devices, and processor(s) 1214 may be housed with different devices.

Bus 1210 represents what may be one or more busses (such as an address bus, data bus, or a combination thereof). Although the various blocks of FIG. 12 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 12 and the references herein to a “computing device.” Memory 1212 may take the form of the computer storage media referenced below and operatively provide storage of computer-readable instructions, data structures, program modules and other data for the computing device 1200. In some examples, memory 1212 stores one or more of an operating system, a universal application platform, or other program modules and program data. Memory 1212 is thus able to store and access data 1212a and instructions 1212b that are executable by processor 1214 and configured to carry out the various operations disclosed herein.

In some examples, memory 1212 includes computer storage media. Memory 1212 may include any quantity of memory associated with or accessible by the computing device 1200. Memory 1212 may be internal to the computing device 1200 (as shown in FIG. 12), external to the computing device 1200 (not shown), or both (not shown). Additionally, or alternatively, the memory 1212 may be distributed across multiple computing devices 1200, for example, in a virtualized environment in which instruction processing is carried out on multiple computing devices 1200. For the purposes of this disclosure, “computer storage media,” “computer-storage memory,” “memory,” and “memory devices” are synonymous terms for the computer-storage memory 1212, and none of these terms include carrier waves or propagating signaling.

Processor(s) 1214 may include any quantity of processing units that read data from various entities, such as memory 1212 or I/O components 1220. Specifically, processor(s) 1214 are programmed to execute computer-executable instructions for implementing aspects of the disclosure. The instructions may be performed by the processor, by multiple processors within the computing device 1200, or by a processor external to the client computing device 1200. In some examples, the processor(s) 1214 are programmed to execute instructions such as those illustrated in the flow charts discussed below and depicted in the accompanying drawings. Moreover, in some examples, the processor(s) 1214 represent an implementation of analog techniques to perform the operations described herein. For example, the operations may be performed by an analog client computing device 1200 and/or a digital client computing device 1200. Presentation component(s) 1216 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1200, across a wired connection, or in other ways. I/O ports 1218 allow computing device 1200 to be logically coupled to other devices including I/O components 1220, some of which may be built in. Example I/O components 1220 include, for example but without limitation, a microphone, joystick, game pad, satellite dish, scanner, printer, wireless device, etc.

Computing device 1200 may operate in a networked environment via the network component 1224 using logical connections to one or more remote computers. In some examples, the network component 1224 includes a network interface card and/or computer-executable instructions (e.g., a driver) for operating the network interface card. Communication between the computing device 1200 and other devices may occur using any protocol or mechanism over any wired or wireless connection. In some examples, network component 1224 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1224 communicates over wireless communication link 1226 and/or a wired communication link 1226a to a remote resource 1228 (e.g., a cloud resource) across network 1230. Various different examples of communication links 1226 and 1226a include a wireless connection, a wired connection, and/or a dedicated link, and in some examples, at least a portion is routed through the internet.

Although described in connection with an example computing device 1200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
identify training samples from a dataset via active learning using a teacher model;
generate soft labels for the training samples using a large language machine learning model (LLM);
dynamically alter a few-shot learning prompt for the LLM, including labeled samples that a student model determines to be similar to a current training sample;
train the student model using the training samples, the student model being configured to output class membership probabilities;
evaluate a performance metric of the student model based on human-annotated ground truth samples;
identify an additional training sample from the dataset using the teacher model;
receive first user input identifying annotation data for the additional training samples; and
retrain the student model using at least the training samples and the additional training sample.

2. The system of claim 1, wherein the instructions are further operative to:
cause a user interface (UI) to be displayed on a display device, the UI including a graph comprising data points, each of the data points representing a training sample from the training samples;
receive second user input indicating selection of a first data point;
cause to be displayed sample data associated with the first data point; and
receive third user input identifying a label for the first data point, thereby causing the first data point to become a human-annotated training sample of the additional training sample used to retrain the student model.

3. The system of claim 2, wherein the instructions are further operative to:
in response to receiving the second user input indicating selection of the first data point, prompt the LLM to generate a label recommendation for the first data point,
wherein causing to be displayed sample data associated with the first data point includes causing the label recommendation to be displayed.

4. The system of claim 1, wherein the instructions are further operative to:
cause a user interface (UI) to be displayed on a display device, the UI including a graph comprising data points, each of the data points representing a training sample from the training samples;
receive second user input indicating selection of a region of the graph;
identify data points occurring within the region;
cause the UI to display sample data for each of the data points occurring within the region; and
receive additional user input identifying a label for each of the data points.

5. The system of claim 1, wherein the instructions are further operative to:
perform iterations of student model retraining;
at each of the iterations of student model retraining:
compare a current performance metric of a current student model to a previous performance metric of a prior student model, thereby identifying a performance differential; and
based on the comparison, add an additional soft labeled training sample to the training samples when the performance differential is above a threshold and add an additional human-labeled training sample to the training samples when the performance differential is below the threshold.

6. The system of claim 1, wherein the instructions are further operative to:
determine, using the student model, a class membership probability for a first sample belonging to a first class; and
assign the first class as a soft label to the first sample when the class membership probability is above a threshold.

7. The system of claim 1, wherein the student model is trained as a multilayer perceptron neural network, wherein the training samples include text-based data, wherein the instructions are further operative to generate embeddings for at least the training samples using the LLM.

8. A computer-implemented method comprising:
identifying training samples from a dataset via active learning using a teacher model;
generating soft labels for the training samples using a large language machine learning model (LLM);
generating a few-shot learning prompt for the LLM, including labeled samples that a student model determines to be similar to a current training sample;
training the student model using the training samples;
evaluating a performance metric of the student model based on a plurality of human-annotated ground truth samples;
identifying an additional training sample from the dataset using the teacher model;
receiving first user input identifying annotation data for the additional training sample; and
retraining the student model using at least the training samples and the additional training sample.

9. The method of claim 8, further comprising:
applying the retrained student model to input data to classify the input data, wherein the input data is selected from a group consisting of the following: text, audio, video, and an image.

10. The method of claim 8, further comprising:
applying the retrained student model to input data to classify the input data, wherein the input data is selected from a group consisting of the following: a support ticket, an insurance claim, social media content, a medical record, an image, a video, stock exchange data, an online review, a customer complaint, a video interview, a DNA sequence, and a biography.

11. The method of claim 8, further comprising:
displaying a user interface (UI), the UI including a graph comprising data points, each of the data points representing one of the training samples;
receiving second user input indicating selection of a region of the graph;
identifying one or more data points occurring within the region;
displaying sample data for each of the data points occurring within the region; and
receiving additional user input identifying a label for each of the data points.

12. The method of claim 8, further comprising:
performing iterations of student model retraining;
at each of the iterations of student model retraining:
comparing a current performance metric of a current student model to a previous performance metric of a prior student model, thereby identifying a performance differential; and
based on the comparing, adding an additional soft labeled training sample to the training samples when the performance differential is above a threshold, otherwise adding an additional human-labeled training sample to the training samples when the performance differential is equal to or less than the threshold.

13. The method of claim 8, further comprising:
determining, using the student model, a class membership probability for a first sample belonging to a first class; and
assigning the first class as a soft label to the first sample when the class membership probability is above a predefined threshold.

14. The method of claim 8, wherein the student model is trained as a multilayer perceptron neural network configured to produce class membership probabilities for input samples, wherein the training samples include text-based data, the method further comprising generating embeddings for at least the training samples using the LLM.

15. A computer storage device having computer-executable instructions stored thereon, which, on execution by a computer, cause the computer to perform operations comprising:
identifying training samples from a dataset via active learning using a teacher model;
generating soft labels for the training samples using a large language machine learning model (LLM);
generating a few-shot learning prompt for the LLM, including labeled samples that a student model determines to be similar to a current training sample;
training the student model using the training samples, the student model being configured to output class membership probabilities;
evaluating a performance metric of the student model based on human-annotated ground truth samples;
identifying an additional training sample from the dataset using the teacher model;
receiving first user input identifying annotation data for the additional training sample; and
retraining the student model using at least the training samples and the additional training sample.

16. The computer storage device of claim 15, the operations further comprising:
displaying a user interface (UI), the UI including a graph comprising data points, each of the data points representing a training sample from the training samples;
receiving second user input indicating selection of a first data point;
displaying sample data associated with the first data point; and
receiving third user input identifying a label for the first data point, thereby causing the first data point to become a human-annotated training sample of the additional training sample used to retrain the student model.

17. The computer storage device of claim 16, the operations further comprising:
in response to receiving the second user input indicating selection of the first data point, causing the LLM to generate a label recommendation for the first data point,
wherein displaying sample data associated with the first data point includes causing the label recommendation to be displayed.

18. The computer storage device of claim 15, the operations further comprising:
displaying a user interface (UI), the UI including a graph comprising data points, each of the data points representing a training sample from the training samples;
receiving second user input indicating selection of a region of the graph;
identifying one or more data points occurring within the region;
displaying sample data for each of the data points occurring within the region; and
receiving additional user input identifying a label for each data point of the data points.

19. The computer storage device of claim 15, the operations further comprising:
performing iterations of student model retraining;
at each of the iterations of student model retraining:
comparing a current performance metric of a current student model to a previous performance metric of a prior student model, thereby identifying a performance differential; and
based on the comparing, adding an additional soft labeled training sample to the training samples when the performance differential is above a threshold, otherwise adding an additional human-labeled training sample to the training samples when the performance differential is equal to or less than the threshold.

20. The computer storage device of claim 15, the operations further comprising:
determining, using the student model, a class membership probability for a first sample belonging to a first class; and
assigning the first class as a soft label to the first sample when the class membership probability is above a predefined threshold.
